(19) United States
(12) Patent Application Publication
(10) Pub. No.: US 2024/0236877 A1
(43) Pub. Date: Jul. 11, 2024

(54) SIGNALING ENHANCEMENTS TO INDICATE RF EXPOSURE DEPENDENCE ACROSS BANDS

(71) Applicant: QUALCOMM Incorporated, San Diego, CA (US)

(72) Inventors: Gokul SRIDHARAN, Sunnyvale, CA (US); Kazuki TAKEDA, Minato-ku (JP); Farhad MESHKATI, San Diego, CA (US); Peter GAAL, San Diego, CA (US)

(21) Appl. No.: 18/408,049

(22) Filed: Jan. 9, 2024

Related U.S. Application Data
(60) Provisional application No. 63/479,164, filed on Jan. 9, 2023.

(51) Int. Cl. H04W 52/36

(52) U.S. Cl. CPC H04W 52/367; H04W 52/365

(57) ABSTRACT

A method for wireless communication at a UE and related apparatus are provided. In the method, the UE first transmits, to a network entity, RF information indicating coupling states of multiple bands of the UE based on an RF exposure of the multiple bands. The UE then communicates, after providing the RF information indicating the coupling states, with the network entity through one or more of the multiple bands.

### CROSS REFERENCE TO RELATED APPLICATION(S)

This application claims the benefit of and priority to U.S. Provisional Application Ser. No. 63/479,164, entitled “SIGNALING ENHANCEMENTS TO INDICATE RF EXPOSURE DEPENDENCE ACROSS BANDS” and filed on Jan. 9, 2023, which is expressly incorporated by reference herein in its entirety.

### TECHNICAL FIELD

The present disclosure relates generally to communication systems, and more particularly, to wireless communication with signaling enhancements to indicate radio frequency (RF) exposure dependence across bands.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include memory and at least one processor coupled to the memory. Based at least in part on information stored in the memory, the at least one processor may be configured to transmit, to a network entity, radio frequency (RF) information indicating coupling states of multiple bands of the UE based on an RF exposure of the multiple bands; and communicate, after providing the RF information indicating the coupling states, with the network entity through one or more of the multiple bands.

In an aspect of the disclosure, a method, a computer-readable medium, and an apparatus are provided for wireless communication at a network entity. The apparatus may include memory and at least one processor coupled to the memory. Based at least in part on information stored in the memory, the at least one processor may be configured to receive, from a UE, RF information indicating coupling states of multiple bands of the UE based on an RF exposure of the multiple bands; and schedule communication with the UE on one or more of the multiple bands based on the coupling states of the multiple bands.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example UE radio frequency (RF) with FR1 DL carrier aggregation (CA).

FIG. 5 is a diagram illustrating an example of instantaneous transmit power determination based on the allowed RF exposure, in accordance with various aspects of the present disclosure.

FIG. 6 is a diagram illustrating an example of instantaneous transmit power determination based on the allowed RF exposure, in accordance with various aspects of the present disclosure.

FIG. 7 is a diagram illustrating an example energy headroom report (EHR) by a UE, in accordance with various aspects of the present disclosure.

FIG. 8 is a diagram illustrating various instantaneous power levels based on an allowed RF exposure, in accordance with various aspects of the present disclosure.

FIG. 9 is a diagram illustrating RF exposure dependency across bands, in accordance with various aspects of the present disclosure.

FIG. 10 is a diagram illustrating an example single entry (power headroom report) PHR medium access control (MAC)-control element (MAC-CE), in accordance with various aspects of the present disclosure.

FIG. 11 is a call flow diagram illustrating a method of wireless communication in accordance with various aspects of the present disclosure.

FIG. 12 is a flowchart illustrating methods of wireless communication at a UE in accordance with various aspects of the present disclosure.

FIG. 13 is a flowchart illustrating methods of wireless communication at a UE in accordance with various aspects of the present disclosure.

FIG. 14 is a flowchart illustrating methods of wireless communication at a UE in accordance with various aspects of the present disclosure.

FIG. 15 is a flowchart illustrating methods of wireless communication at a network entity in accordance with various aspects of the present disclosure.

FIG. 16 is a flowchart illustrating methods of wireless communication at a network entity in accordance with various aspects of the present disclosure.

FIG. 17 is a flowchart illustrating methods of wireless communication at a network entity in accordance with various aspects of the present disclosure.

FIG. 18 is a diagram illustrating an example of a hardware implementation for an example apparatus and/or network entity.

FIG. 19 is a diagram illustrating an example of a hardware implementation for an example network entity.

### DETAILED DESCRIPTION

In wireless communication, the management of radio frequency (RF) exposure across different frequency bands is an important aspect that affects network and device performance. RF exposure may be influenced by various factors, including antenna placement, which in turn affects absorption of RF energy. When multiple frequency bands are utilized by a user equipment (UE), the interaction between these bands (e.g., whether they are coupled or decoupled) may impact the UE's capability to transmit efficiently and safely. The network (e.g., a base station) might not know information about the UE's internal RF architecture. As a result, there is a growing need for methods and apparatus that allow for better communication and understanding of these RF characteristics between the UE and the network.

Various aspects relate generally to wireless communication. Some aspects more specifically relate to methods and apparatus for signaling enhancements to indicate RF exposure dependence across bands. In some examples, the UE may transmit, to a network entity, radio frequency (RF) information indicating coupling states of multiple bands of the UE based on an RF exposure of the multiple bands. The UE may further communicate, after providing the RF information indicating the coupling states, with the network entity through one or more of the multiple bands. In some examples, the UE may transmit, to a network entity, a power headroom report (PHR) including a power management maximum power reduction (P-MPR) value and a time duration associated with the P-MPR value; and receive scheduling from the network entity after providing the PHR with the P-MPR value and the time duration.

Particular aspects of the subject matter described in this disclosure can be implemented to realize one or more of the following potential advantages. In some examples, by transmitting to the network entity RF information indicating coupling states of multiple bands of the UE based on an RF exposure of the multiple bands, the described techniques can be used to provide signaling mechanisms to inform the network entity about the underlying UE implementation related to the RF exposure associated with the UL transmission. The method allows the network entity to better plan future scheduling from the RF exposure standpoint. Hence, it improves the efficiency of wireless communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well-known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

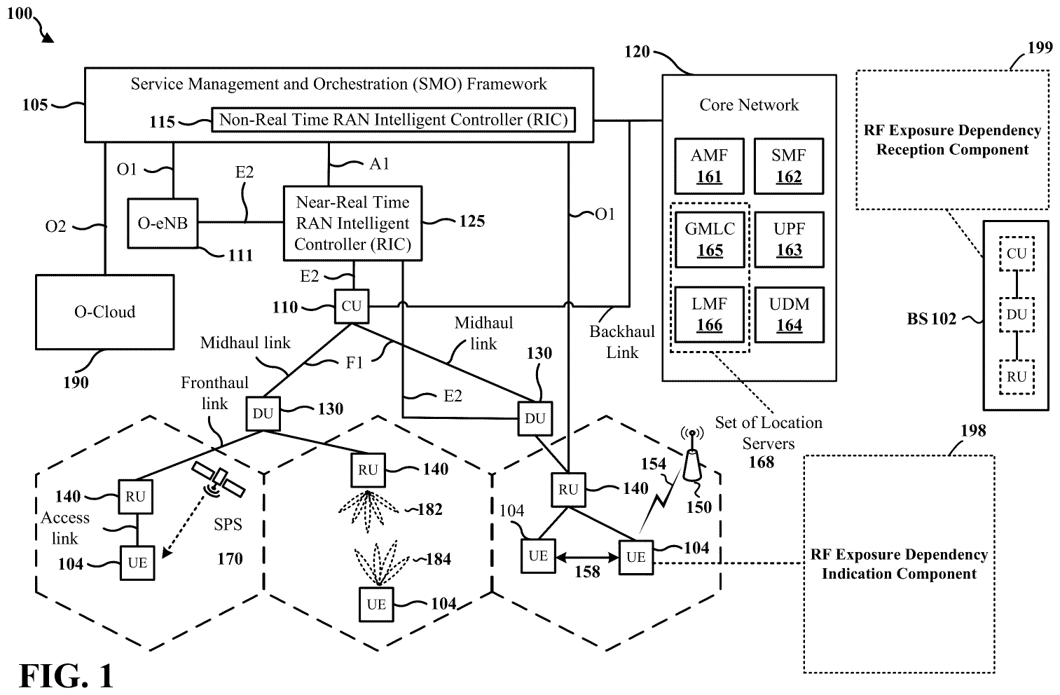

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHz-7.125 GHz) and FR2 (24.25 GHz-52.6 GHz). Although a portion of FR1 is greater than 6 GHz, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FRI characteristics and/or FR2 characteristics, and thus may effectively extend features of FRI and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FRI, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an RF exposure dependency indication component 198. The RF exposure dependency indication component 198 may be configured to transmit, to a network entity, RF information indicating coupling states of multiple bands of the UE based on an RF exposure of the multiple bands; and communicate, after providing the RF information indicating the coupling states, with the network entity through one or more of the multiple bands. In certain aspects, the base station 102 may include an RF exposure dependency reception component 199. The RF exposure dependency reception component 199 may be configured to receive, from a UE, RF information indicating coupling states of multiple bands of the UE based on an RF exposure of the multiple bands; and schedule communication with the UE on one or more of the multiple bands based on the coupling states of the multiple bands. Although the following description may be focused on 5G NR, the concepts described herein may be applicable to other similar areas, such as LTE, LTE-A, CDMA, GSM, and other wireless technologies.

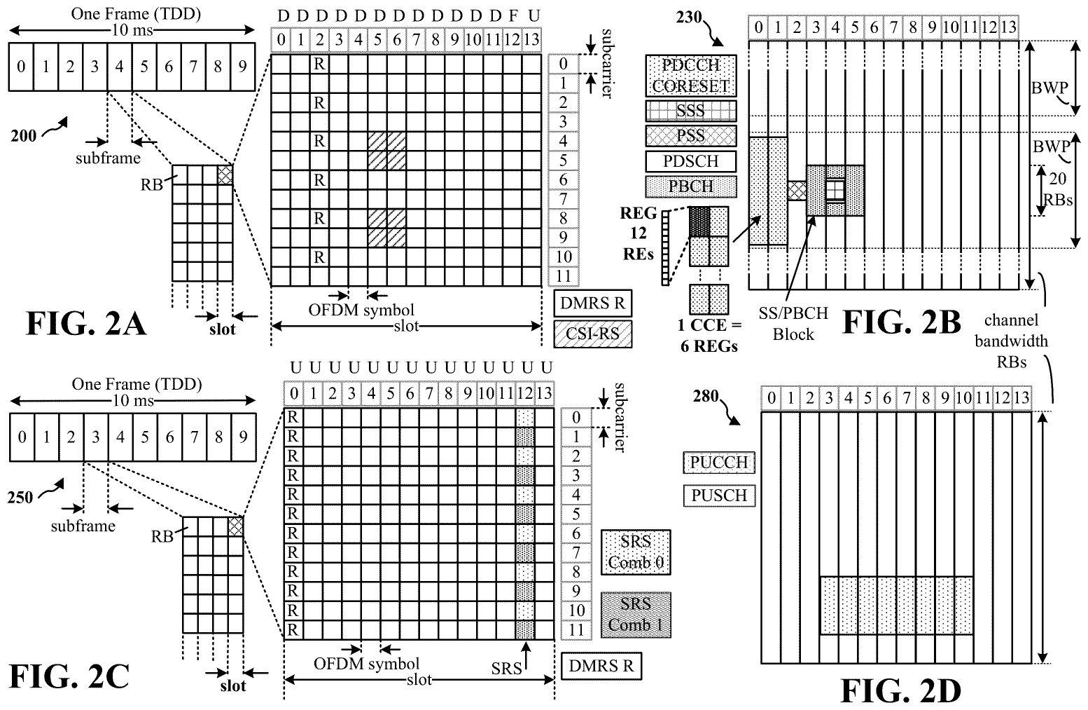

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

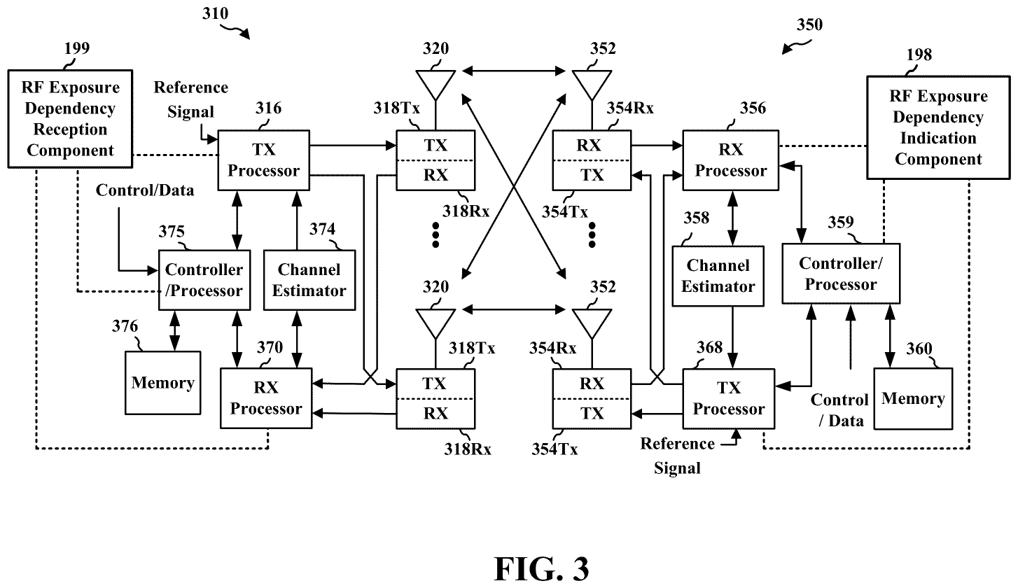

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the RF exposure dependency indication component 198 of FIG. 1.

At least one of the TX processor 316, the RX processor 370, and the controller/processor 375 may be configured to perform aspects in connection with the RF exposure dependency reception component 199 of FIG. 1.

In wireless communication, DL carrier aggregation (CA) may be provided for a UE. For UL, the UE transmit power has different considerations for UL CA than for DL CA. For example, UL transmission power takes into consideration an RF exposure for the user of the UE. In a large portion of a cell coverage area, the UE may be able to efficiently use only a fraction of the BW of a single carrier. Hence, merely aggregating Carrier Components (CCs) without a corresponding increase in the transmit power is futile and may not bring any benefits.

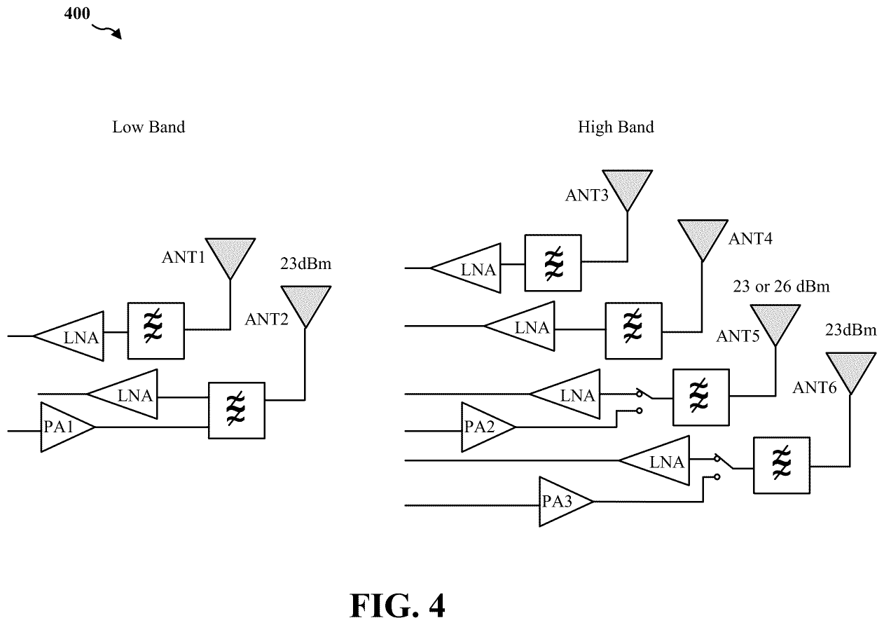

A UE may operate on multiple bands, and every band the UE supports may represent potential transmit power. However, the UE may be limited by the sum-power constraint (e.g., powerClass per Band combination) in inter-band CA. FIG. 4 is a diagram 400 illustrating an example UE RF with FRI DL CA. In the example shown in FIG. 4, the UE may operate on two bands (e.g., the Low Band and the High Band). The Low Band may include one power amplifier (e.g., PA1) and two antennas (e.g., ANT1, ANT2), and may reach a signal strength of 23 decibels (dBm). The High Band may include two PA (e.g., PA2 and PA3) and four antennas (e.g., ANT3, ANT4, ANT5, and ANT6), and may reach a signal strength of 23 or 26 dBm. Hence, the UE with FR1 DL CA may include a total of six antennas (e.g., ANT1-ANT6) and three PAs (e.g., PA1, PA2, and PA3). The combined signal strength may be, for example, 28 dBm or 29 dBm. By coordinating the operation on multiple bands, a higher UE power limit may be realized for CA and Dual Connectivity (DC) scenarios.

Dynamic power aggregation is presented in order to more fully use a UE's ability for simultaneous transmission to allow full utilization of available transmit power in short bursts. Additionally, a new framework may be introduced to better inform the base station of the UE power budget and Specific Absorption Rate (SAR) compliance (e.g., with a more detailed PHR). Fully utilizing the available transmit power of a UE may provide the UL data rate boost and increase the UL user-perceived throughput.

To facilitate higher power transmission in UL CA and DC scenarios, corresponding signaling mechanisms between the UE and the base station are presented. The signaling mechanisms may increase the awareness at a network device of the power or energy budget available at the UE for each carrier/band. The signaling mechanism may aid the selection of the best band combination for UL CA, and aid the scheduling policy when the UE is configured with multiple bands in UL CA or DC (e.g., selecting the preferred carrier for servicing uplink or adaptive load sharing across carriers).

The RF exposure constraints may play an important role in determining the high-power transmission at the UE. Regulatory constraints may impose restrictions on the maximum permissible exposure. In the sub-6 GHz band (e.g., FR1), the exposure may be governed by SAR, while in the millimeter wave (mmW) band (e.g., a frequency band of 30-300 GHz), the exposure may be governed by Power Density (PD). In one example, the RF exposure constraints may be described as:

$${Σ}_{i = 100 k H z}^{6 G H z} \frac{{SAR}_{i}}{S A {R}_{lim}} + {Σ}_{j = 6 G H z}^{300 G H z} \frac{P {D}_{j}}{P {D}_{lim}} \leq 1$$

where

$$S A {R}_{i} = \frac{1}{{T}_{S A R}} {\int }_{t - {T}_{S A R}}^{t} S A {R}_{i} ( τ ) d τ ,$$

and

$$P {D}_{j} = \frac{1}{{T}_{P D}} {\int }_{t - {T}_{P D}}^{t} P {D}_{j} ( τ ) d τ .$$

T_{SAR} is the integration time for SAR, and T_{PD} is the integration time for PD. As shown in Equation (1), the regulatory constraint on RF exposure may be determined by the time-averaged RF exposure, not by an instantaneous RF exposure.

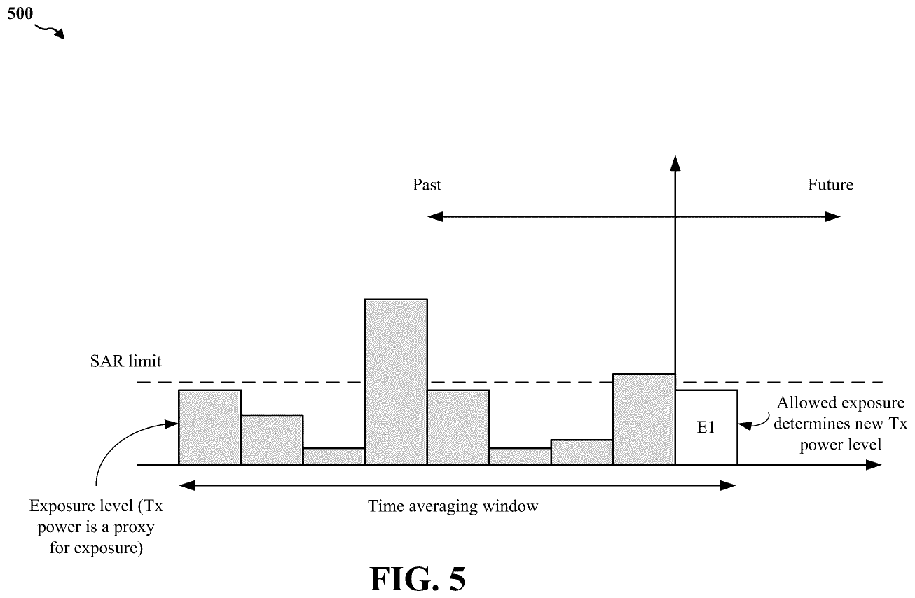

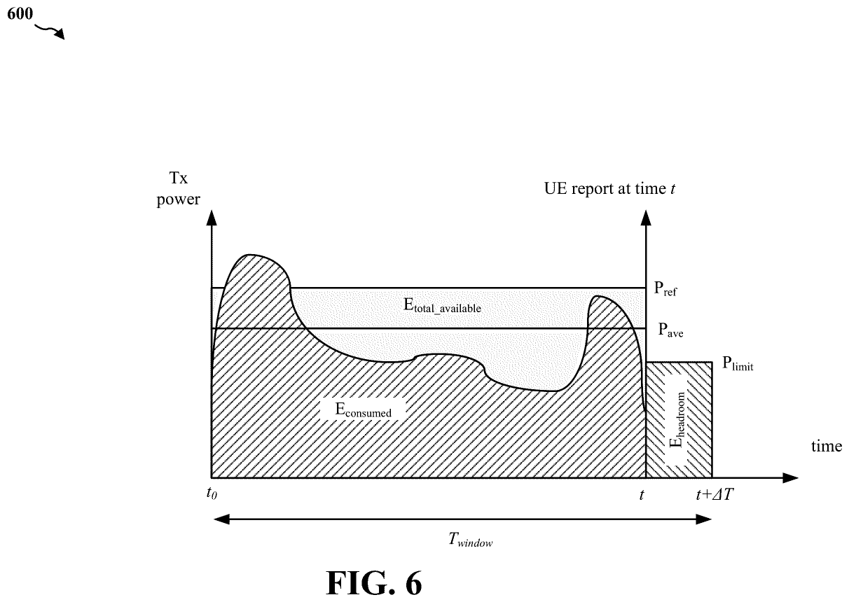

A UE may determine the allowed RF exposure for a short duration of time in the future. Based on the allowed RF exposure, the UE may determine the instantaneous transmit power based on the transmission requirements in UL. FIGS. 5 and 6 are diagrams 500 and 600, respectively, illustrating examples of instantaneous transmit power determination based on the allowed RF exposure, in accordance with various aspects of the present disclosure. As shown in FIG. 5, a UE may determine an allowed RF exposure (e.g., E1) in the future. Based on the allowed exposure (e.g., E1), the UE may determine instantaneous transmit power based on the transmission requirements in UL. As shown in FIG. 6, the UE may estimate an energy headroom (e.g., E_{headroom}) for a short duration of time in the future (e.g., from t to 1+ΔT). The energy headroom may be computed by:

$${E}_{headroom} = {E}_{total \_ available} - {E}_{consumed}$$

where E_{consumed}=∫_{t+ΔT-T}_{_{window}}^{t}P(τ)dτ (which is the area of the patterned region in the time period of t₀ to t in FIG. 6), E_{total_available}=P_{ref}×T_{window}. P_{ref} is the reference power level the UE may transmit at based on the total available energy, P(τ) is an instantaneous power level at time τ. Since E_{headroom}=Pₗᵢₘᵢₜ×ΔT, the UE may determine the instantaneous transmit power Pₗᵢₘᵢₜ over the period of time ΔT in the future based on E_{headroom}.

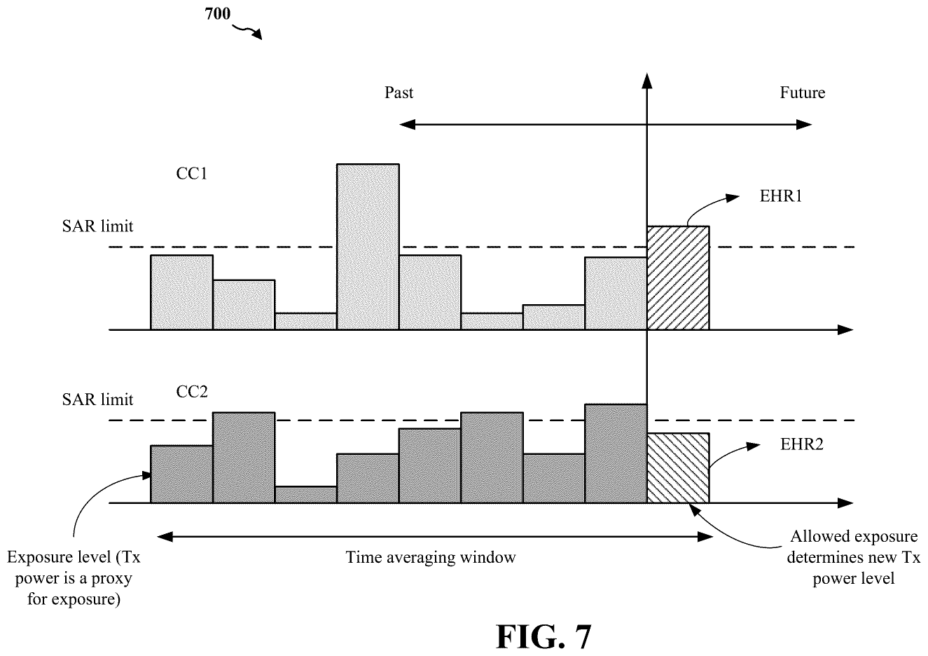

In some aspects, the UE may report the budget for the RF exposure through signaling. For example, the UE may use medium access control (MAC)-control element (MAC-CE) signaling to report the energy headroom/budget for each of the bands in a CA/DC configuration to the UE. FIG. 7 is a diagram 700 illustrating an example energy headroom report (EHR) by a UE, in accordance with various aspects of the present disclosure. As shown in FIG. 7, the UE may determine the allowed exposure for the first carrier component (e.g., CC1) for a short or reduced period of time in the future, and report the energy headroom/budget in the first energy headroom report (e.g., EHR1). Similarly, the UE may determine the allowed exposure for the second carrier component (e.g., CC2) for a short period of time, or a reduced period of time, in the future, and report the energy headroom/budget in the second energy headroom report (e.g., EHR2).

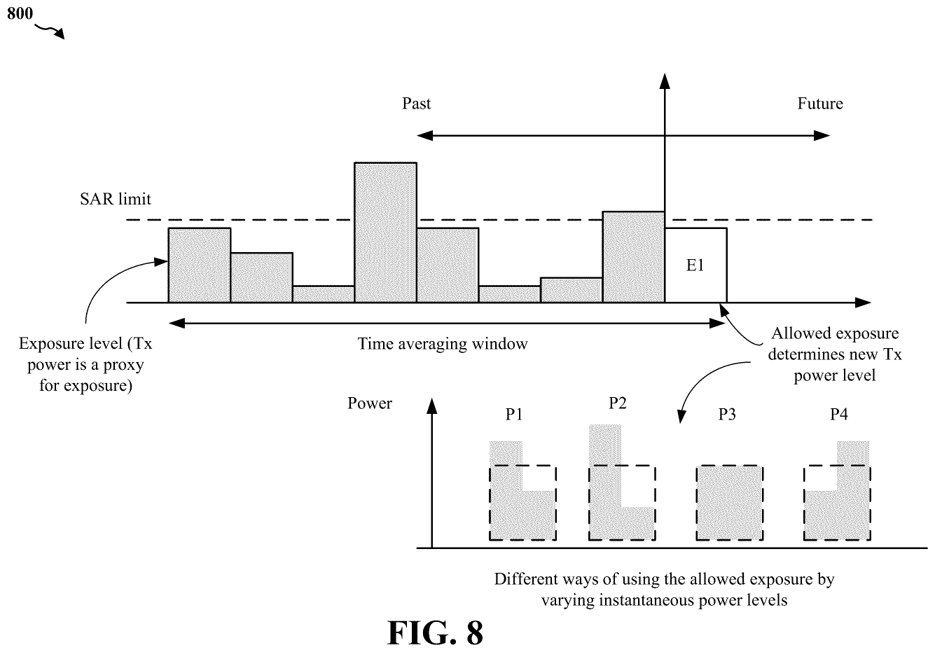

Based on the allowed RF exposure for the short period of time in the future, the UE may estimate instantaneous transmit power based on the transmission requirement in UL. FIG. 8 is a diagram 800 illustrating various instantaneous power levels based on an allowed RF exposure, in accordance with various aspects of the present disclosure. As shown in FIG. 8, a UE may first determine the allowed RF exposure (e.g., E1) for the short period of time in the future. Based on the allowed RF exposure (e.g., E1), various instantaneous power schemes (e.g., P1, P2, P3, and P4) may be used. For example, the UE may choose to boost its power to support a subset of the uplink grants that are received within a certain time window (e.g., in P2, the UE may boost its power at the first half of the time window).

In wireless communication, antenna placement may impact the RF exposure of a UE to a human operator, which may be subject to relevant regulation to ensure the safe operation of a UE. When a UE is operating across multiple bands, the combination or alternating of the multiple bands may further complicate the RF exposure of the UE.

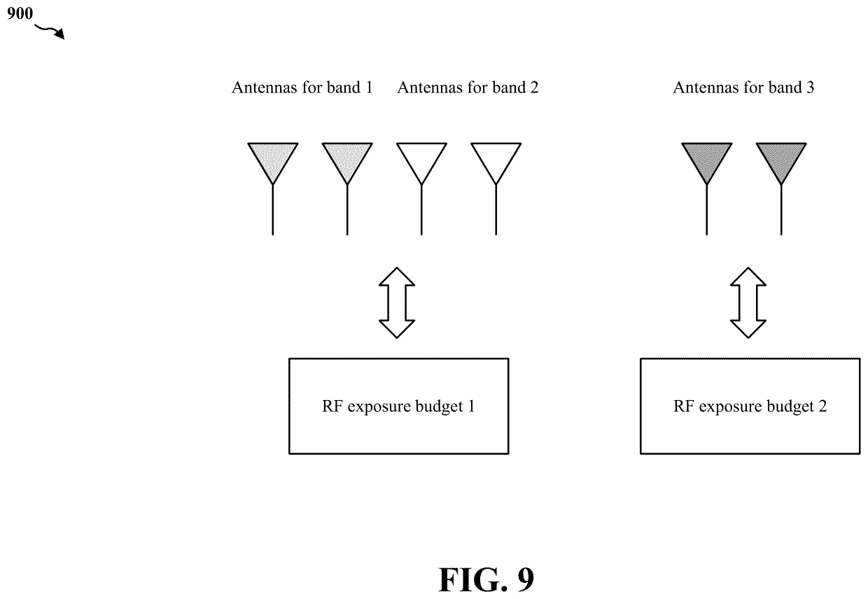

When a UE operates across multiple bands, the multiple bands may have a shared RF exposure budget or an independent RF exposure budget. FIG. 9 is a diagram 900 illustrating RF exposure dependency across bands. As shown in FIG. 9, in one example, one RF exposure budget (e.g., RF exposure budget 1) may be coupled (e.g., shared) between multiple bands of the UE (e.g., Band 1 and Band 2). In another example, one band of the UE (e.g., Band 3) may have an independent RF exposure budget (e.g., RF exposure budget 2). That is, the RF exposure due to this band (e.g., Band 3) may be independent of the RF exposure incurred due to other bands (e.g., Band 1 and Band 2).

When multiple bands share an RF exposure budget, the shared RF exposure budget may work as a sum power constraint across the multiple bands. If the multiple bands that share an RF exposure budget are scheduled simultaneously, the RF exposure budget may deplete quickly, which may be detrimental to the efficient operation of the UE. Additionally, even if the multiple bands are powered by individual power amplifiers (PAs), a UE may not be able to sustain the high-power transmission across the multiple bands for a long period of time.

On the other hand, if the multiple bands have independent RF exposure budgets, the UE may transmit over these bands in a more independent manner than the bands with a shared RF exposure budget. Hence, the bands with independent RF exposure budgets may be better suited to be scheduled simultaneously than the bands with a shared RF exposure budget.

Whether the multiple bands of a UE have a shared RF exposure budget or an independent RF exposure budget may be determined by the UE implementation based on various factors. These factors may include, but not limited to, the RF architecture, the locations of the antennas, the design of the antennas, the number of antennas being used, and whether antenna diversity schemes are employed.

As the base station may not have sufficient information regarding the underlying UE implementation, the base station may not be aware of the RF exposure dependency information on the UE. Hence, signaling mechanisms are provided herein to indicate the RF exposure dependency information for the base station to better schedule communication resources from an RF exposure standpoint.

The present disclosure provides methods and apparatus for signaling enhancements to indicate RF exposure dependence across bands. In some aspects, a UE may report the RF exposure dependency across bands through capability reporting. For example, the UE may indicate, to the base station, the bands whose RF exposures are decoupled or alternately, which may encourage the base station to schedule this combination of bands in uplink. The UE may also indicate the bands whose RF exposure is coupled or alternately, which may discourage the base station from scheduling this combination of bands in uplink. Additionally, the UE may indicate one or more preferred band combinations from an RF exposure standpoint. For example, the UE may report one or more band combinations that do not share an RF exposure budget. The UE may provide the capability reporting indicating the RF exposure dependency across bands once during a call setup, and such reporting may be suitable for communication with certain bands where the antennas are well separated.

In some aspects, a UE may report the RF exposure dependency across bands through dynamic signaling. For example, a UE may use a power headroom report (PHR) to report the set of bands for a given CA configuration that works best from an RF exposure standpoint and pairs well for simultaneous transmissions in UL-CA. The UE may report the RF exposure dependency across bands for multiple CCs through multiple PHRs, with each PHR carrying entries for one corresponding CC of the multiple CCs. In one example, one bit per CC may be used to indicate the band grouping that works well for UL-CA. For example, a binary stream of [1 0 0 1] may indicate that the first and the four bands pair well for UL-CA. The dynamic signaling from the UE may act as a suggestion to the base station on preferred Band pair switching choices, and the UE may change the set of preferred bands over time, which provides more flexibility to the UE.

In some aspects, the UE may signal to the base station the P-MPR in the PHR to inform the base station of the current value of P-MPR. In some aspects, the UE may further signal a time duration to the base station. The time duration may be indicated as an additional field in the PHR and may indicate the time period the P-MPR reported in the PHR may be in effect. In some examples, the time duration may be one of a set of given values. For example, the time duration may be one of a set of values: {50, 100, 150, . . . , 500} ms, and the additional field in the PHR for the time duration may be 3-4 bits. The dynamic signaling from the UE may provide information for the base station to determine whether to continue scheduling on a given band/CC, which may facilitate the base station to better plan future scheduling decisions.

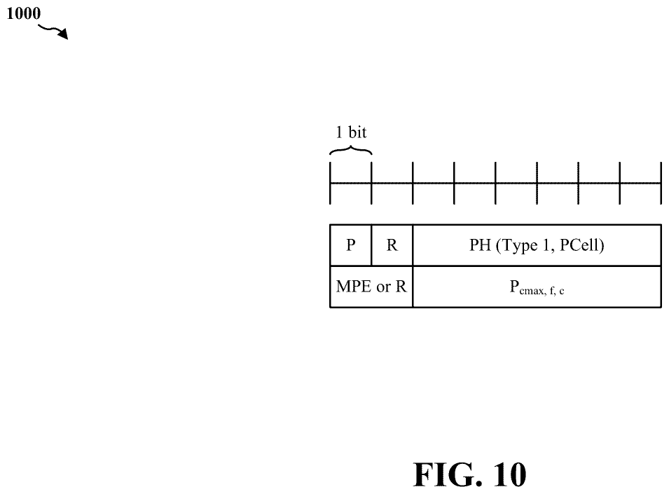

FIG. 10 is a diagram 1000 illustrating an example single entry PHR MAC-CE, in accordance with various aspects of the present disclosure. In the example of FIG. 10, the MAC-CE may include a 1-bit P field that indicates whether Maximum Permissible Exposure (MPE) is being reported, a 6-bit power headroom (PH) field, a 2-bit MPE field, and a 6-bit field (P_{cmax, f, c}) that reports the UE-configured maximum output power. Tables 2, 3, and 4 show the example MAC-CE fields for PHR and P-MPR.

TABLE 2
Power Headroom Levels for PHR

| PH | Power Headroom Level |
|---|---|
| 0 | POWER_HEADROOM_0 |
| 1 | POWER_HEADROOM_1 |
| 2 | POWER_HEADROOM_2 |
| 3 | POWER_HEADROOM_3 |
| . . . | . . . |
| 61 | POWER_HEADROOM_61 |
| 62 | POWER_HEADROOM_62 |
| 63 | POWER_HEADROOM_63 |

TABLE 3
Nominal UE transmit power level for PHR

| | Nominal UE transmit |
|---|---|
| P_{cmax, f, c} | power level |
| 0 | PCMAX_C_00 |
| 1 | PCMAX_C_01 |
| 2 | PCMAX_C_02 |
| 3 | PCMAX_C_03 |
| . . . | . . . |
| 61 | PCMAX_C_61 |
| 62 | PCMAX_C_62 |
| 63 | PCMAX_C_63 |

TABLE 4
Effective power reduction for MPE P-MPR

| MPE | Measured P-MPR value |
|---|---|
| 0 | P-MPR_00 |
| 1 | P-MPR_01 |
| 2 | P-MPR_02 |
| 3 | P-MPR_03 |

Referring to FIG. 10, and Tables 2, 3, and 4, in one example, if a parameter, such as mpe-Reporting-FR2, is configured, and the serving cell operates on FR2, and if the P field is set to 1, the MPE field may indicate the applied power backoff to meet MPE requirements. The MPE field may indicate an index to Table 4 and the corresponding measurement values of P-MPR levels in dB. In another example, if parameter mpe-Reporting-FR2 is not configured, or if the Serving Cell operates on FRI, or if the P field is set to 0, the reserved bits (R bits) may be present in the MPE field. In one example, if parameter mpe-Reporting-FR2 is configured, and the serving cell operates on FR2, the MAC entity may set the P field to 0 if the applied P-MPR value, to meet MPE requirements, is less than P-MPR_00 in Table 4 and to 1 otherwise. In another example, if parameter mpe-Reporting-FR2 is not configured, or the serving cell operates on FR1, the P field may indicate whether the power backoff is applied due to power management (as allowed by P-MPR). The MAC entity may set the P field to 1 if the corresponding P_{cmax, f, c}, field would have had a different value if no power backoff due to power management had been applied.

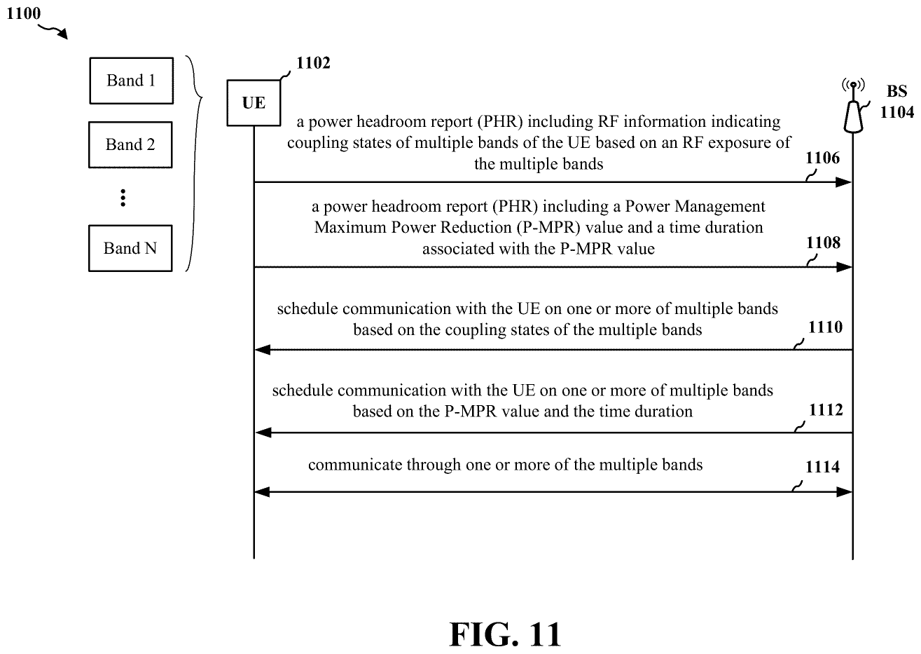

FIG. 11 is a call flow diagram 1100 illustrating a method of wireless communication in accordance with various aspects of this present disclosure. Although aspects are described for a base station 1104, the aspects may be performed by a base station in aggregation and/or by one or more components of a base station 1104 (e.g., such as a CU 110, a DU 130, and/or an RU 140), which may be referred to herein as a network node, network entity, or network device. As shown in FIG. 11, at 1106, a UE 1102 may transmit RF information that indicates the coupling states of the multiple bands of the UE based on an RF exposure of the multiple bands to the base station 1104. The UE 1102 may include multiple bands, such as Band 1, Band 2, . . . , Band N, as shown in FIG. 11. In some examples, the multiple bands may be multiple frequency bands. For example, the multiple bands may include the Low Band and the High Band in FIG. 4. In some examples, the RF information that indicates the coupling states of the multiple bands of the UE may be included in a power headroom report (PHR). For example, referring to FIG. 9, the RF information may be included in a PHR and may indicate that two bands (e.g., band 1 and band 2) are coupled and share an RF exposure budget (e.g., RF exposure budget 1). The RF information may also indicate that two bands (e.g., band 2 and band 3) are decoupled and do not share an RF exposure budget.

At 1108, the UE 1102 may transmit a PHR to the base station 1104. The PHR may include a P-MPR value and a time duration associated with the P-MPR value. For example, the P-MPR value may be transmitted as shown in Table 4. One or more additional fields in the PHR may be used for indicating the time duration associated with the P-MPR value.

At 1110, the base station 1104 may schedule communication with the UE 1102 on one or more of the multiple bands based on the coupling states of the multiple bands. For example, if the PHR the UE 1102 transmits at 1106, indicates that two bands of the UE 1102 are decoupled (e.g., the two bands are band 2 and band 3 in FIG. 9), the base station 1104 may schedule the combination of these two bands in uplink. On the other hand, if the PHR indicates that two bands of the UE 1102 are coupled (e.g., the two bands are band 1 and band 2 in FIG. 9), the base station 1104 may not schedule the combination of these two bands in uplink.

At 1112, the base station 1104 may schedule the UE 1102 for communication on one or more of multiple bands based on the P-MPR value and the time duration.

At 1114, the UE 1102 and the base station 1104 may communicate through one or more of the multiple bands. For example, the UE 1102 may transmit uplink transmissions to the base station 1104 based on the scheduling received from the base station 1104.

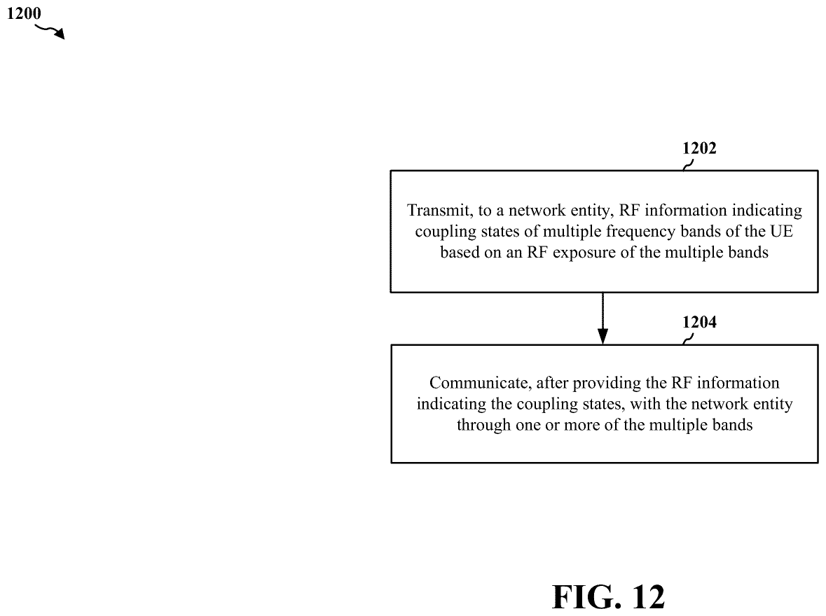

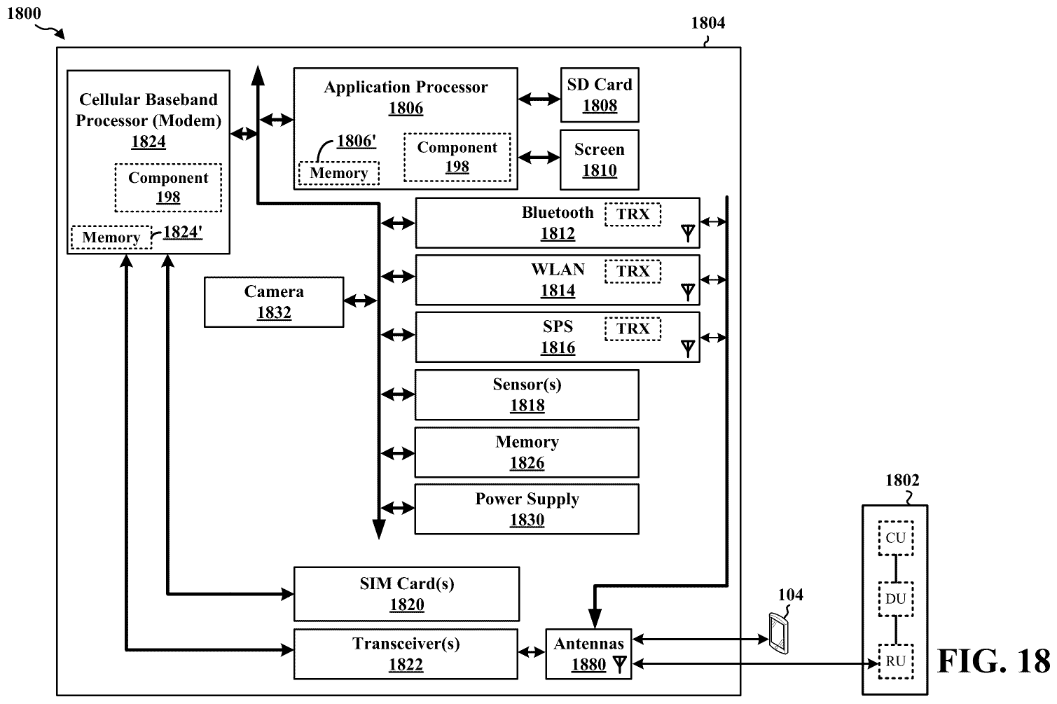

FIG. 12 is a flowchart 1200 illustrating methods of wireless communication at a UE in accordance with various aspects of the present disclosure. The method may be performed by a UE. The UE may be the UE 104, 350, 1102, or the apparatus 1804 in the hardware implementation of FIG. 18. The method provides signaling mechanisms to inform the base station of the underlying UE implementation related to the RF exposure associated with the UL transmission. The method allows the base station to better plan future scheduling from the RF exposure standpoint. Hence, it improves the efficiency of wireless communication.

As shown in FIG. 12, at 1202, the UE may transmit, to a network entity, RF information indicating coupling states of multiple bands of the UE based on an RF exposure of the multiple bands. The network entity may be a base station, or a component of a base station, in the access network of FIG. 1 or a core network component (e.g., base station 102, 310, 1104; or the network entity 1802 in the hardware implementation of FIG. 18). FIGS. 9, 10, and 11 illustrate various aspects of the steps in connection with flowchart 1200. For example, referring to FIG. 11, the UE 1102 may transmit, at 1106 to a network entity (base station 1104), RF information indicating coupling states of multiple bands of the UE based on an RF exposure of the multiple bands. Referring to FIG. 9, the RF information may indicate that band 1 and band 2 of the UE 1102 are coupled and share an RF exposure budget (e.g., RF exposure budget 1). The RF information may further indicate that band 3 is decoupled to either band 1 or band 2, as band 3 does not share an RF exposure budget with band 1 or band 2. In some aspects, 1202 may be performed by the RF exposure dependency indication component 198.

At 1204, the UE may communicate, after providing the RF information indicating the coupling states, with the network entity through one or more of the multiple bands. For example, referring to FIG. 11, the UE 1102 may communicate, at 1114, with the network entity (base station 1104) through one or more of the multiple bands (e.g., Band 1, Band 2, . . . , Band N of the UE 1102). In some aspects, 1204 may be performed by the RF exposure dependency indication component 198.

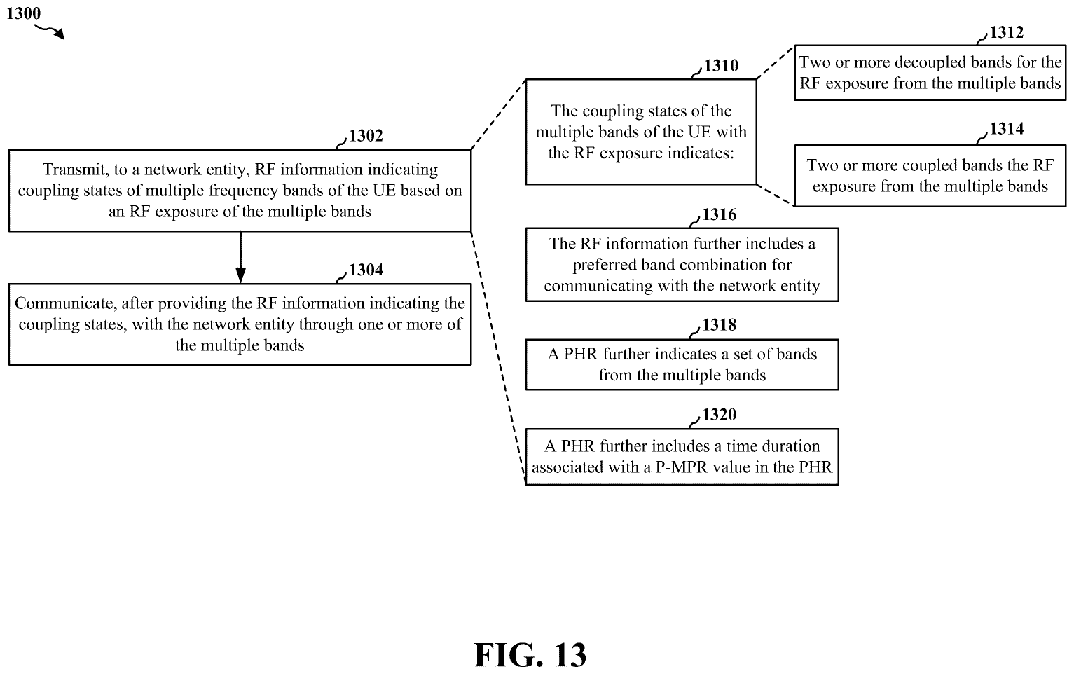

FIG. 13 is a flowchart 1300 illustrating methods of wireless communication at a UE in accordance with various aspects of the present disclosure. The method may be performed by a UE. The UE may be the UE 104, 350, 1102, or the apparatus 1804 in the hardware implementation of FIG. 18. The method provides signaling mechanisms to inform the base station of the underlying UE implementation related to the RF exposure associated with the UL transmission. The method allows the base station to better plan future scheduling from the RF exposure standpoint. Hence, it improves the efficiency of wireless communication.

As shown in FIG. 13, at 1302, the UE may transmit, to a network entity, RF information indicating coupling states of multiple bands of the UE based on an RF exposure of the multiple bands. The network entity may be a base station, or a component of a base station, in the access network of FIG. 1 or a core network component (e.g., base station 102, 310, 1104; or the network entity 1802 in the hardware implementation of FIG. 18). FIGS. 9, 10, and 11 illustrate various aspects of the steps in connection with flowchart 1300. For example, referring to FIG. 11, the UE 1102 may transmit, at 1106 to a network entity (base station 1104), RF information indicating coupling states of multiple bands of the UE based on an RF exposure of the multiple bands. Referring to FIG. 9, the RF information may indicate that band 1 and band 2 of the UE 1102 are coupled and share an RF exposure budget (e.g., RF exposure budget 1). The RF information may further indicate that band 3 is decoupled to either band 1 or band 2, as band 3 does not share an RF exposure budget with band 1 or band 2. In some aspects, 1302 may be performed by the RF exposure dependency indication component 198.

At 1304, the UE may communicate, after providing the RF information indicating the coupling states, with the network entity through one or more of the multiple bands. For example, referring to FIG. 11, the UE 1102 may communicate, at 1114, with the network entity (base station 1104) through one or more of the multiple bands (e.g., Band 1, Band 2, . . . , Band N of the UE 1102). In some aspects, 1304 may be performed by the RF exposure dependency indication component 198.

In some aspects, at 1310, the coupling states of the multiple bands of the UE with the RF exposure may indicate one or more of: at 1312, two or more decoupled bands for the RF exposure from the multiple bands; or, at 1314, two or more coupled bands the RF exposure from the multiple bands. For example, referring to FIG. 9, the coupling states of the multiple bands of the UE may indicate that band 1 and band 2 of the UE are coupled bands and share an RF exposure budget (e.g., RF exposure budget 1), and band 3 is decoupled to either band 1 or band 2, as band 3 does not share an RF exposure budget with band 1 or band 2.

In some aspects, the RF information may further include, at 1316, a preferred band combination for communicating with the network entity. The preferred band combination may include one or more bands of the multiple bands based on an RF exposure metric. For example, referring to FIG. 9, the preferred band combination may include a combination of band I and band 3 because band 1 and band 3 are decoupled and do not share an RF exposure budget.

In some aspects, the RF exposure metric may be related to the sharing of an RF exposure budget, and the one or more bands of the multiple bands may not share the RF exposure budget. For example, referring to FIG. 9, the one or more bands of the multiple bands may be band I and band 3, which do not share the RF exposure budget.

In some aspects, the RF information may be included in a PHR. As an example, at 1318, the PHR may further indicate a set of bands from the multiple bands, based on a CA configuration associated with an RF exposure metric, for uplink transmission to the network entity. For example, referring to FIG. 11, when the UE 1102 transmits, at 1106, the PHR to the base station 1104, the PHR may indicate a set of bands from the multiple bands, based on a CA configuration associated with an RF exposure metric, for uplink transmission to the network entity.

In some aspects, the PHR may indicate the set of bands through a binary string. The binary string may include multiple bits corresponding to the multiple bands. For example, referring to FIG. 11, when the UE 1102 transmits, at 1106, the PHR to the base station 1104, the PHR may indicate the set of bands through a binary string. For example, the binary string may be a 4-bit binary string [1 0 0 1]. Each bit in the binary string may correspond to one band of the multiple bands, and the string [1 0 0 1] may indicate the first and fourth bands pair well for uplink transmission to the network entity (base station 1104).

In some aspects, at 1320, the PHR may further include a time duration associated with a P-MPR value in the PHR. For example, referring to FIG. 11, when the UE 1102 transmits, at 1106, a PHR to the network entity (base station 1104), the PHR may further include a time duration associated with a P-MPR value in the PHR.

In some aspects, the time duration may be indicated as an additional field in the PHR and corresponds to a time period during which the P-MPR value is effective. For example, referring to FIG. 11, when the UE 1102 transmits, at 1106, a PHR to the network entity (base station 1104), the PHR may include the time duration, and the time duration in the PHR may be indicated as an additional field in the PHR and may correspond to a time period during which the P-MPR value is effective.

In some aspects, the time duration may be one of a set of predetermined values. For example, the time duration may be one of a set of given values, such as {50, 100, 150, . . . , 500} ms.

In some aspects, the additional field may be a binary field including multiple binary bits. For example, the additional field may be a 3-bit or 4-bit field.

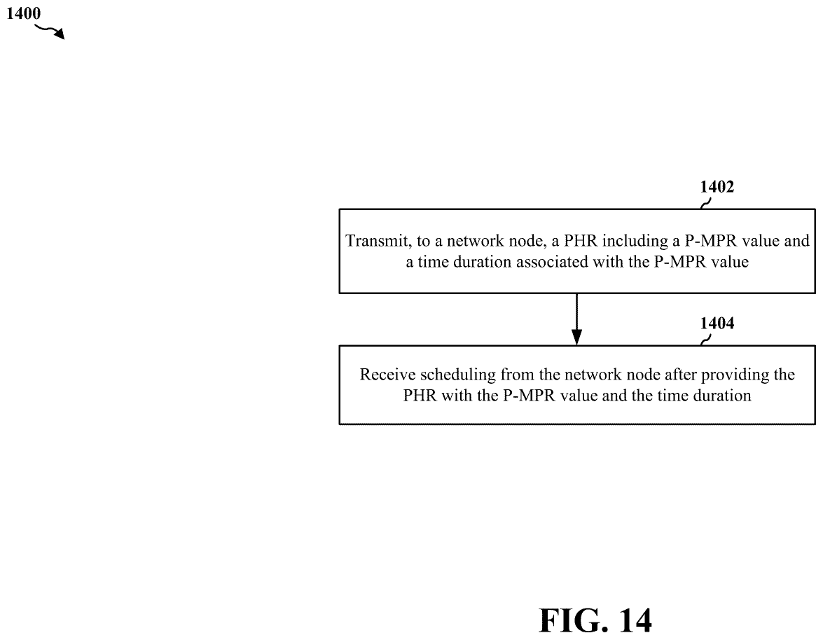

FIG. 14 is a flowchart 1400 illustrating methods of wireless communication at a UE in accordance with various aspects of the present disclosure. The method may be performed by a UE. The UE may be the UE 104, 350, 1102, or the apparatus 1804 in the hardware implementation of FIG. 18. The method provides signaling mechanisms to inform the base station of the underlying UE implementation related to the RF exposure associated with the UL transmission. The method allows the base station to better plan future scheduling from the RF exposure standpoint. Hence, it improves the efficiency of wireless communication.

As shown in FIG. 14, at 1402, the UE may transmit a PHR to a network entity. The PHR may include a P-MPR value and a time duration associated with the P-MPR value. The network entity may be a base station, or a component of a base station, in the access network of FIG. 1 or a core network component (e.g., base station 102, 310, 1104; or the network entity 1802 in the hardware implementation of FIG. 18). FIGS. 9, 10, and 11 illustrate various aspects of the steps in connection with flowchart 1400. For example, referring to FIG. 11, the UE 1102 may transmit, at 1108, a PHR to a network entity (base station 1104). The PHR may include a P-MPR value and a time duration associated with the P-MPR value. In some aspects, 1402 may be performed by the RF exposure dependency indication component 198.

At 1404, the UE may receive scheduling from the network entity after providing the PHR with the P-MPR value and the time duration. For example, referring to FIG. 11, the UE 1102 may receive, at 1112, scheduling from the network entity (base station) after providing the PHR with the P-MPR value and the time duration (at 1108). In some aspects, 1404 may be performed by the RF exposure dependency indication component 198.

In some aspects, the time duration may be indicated as an additional field in the PHR and corresponds to a time period during which the P-MPR value is effective. For example, referring to FIG. 11, when the UE 1102 transmits, at 1108, a PHR to the network entity (base station 1104), the PHR may include the time duration, and the time duration in the PHR may be indicated as an additional field in the PHR and may correspond to a time period during which the P-MPR value is effective.

In some aspects, the time duration may be one of a set of predetermined values. For example, the time duration may be one of a set of given values, such as {50, 100, 150, . . . , 500} ms.

In some aspects, the additional field may be a binary field including multiple binary bits. For example, the additional field may be a 3-bit or 4-bit field.

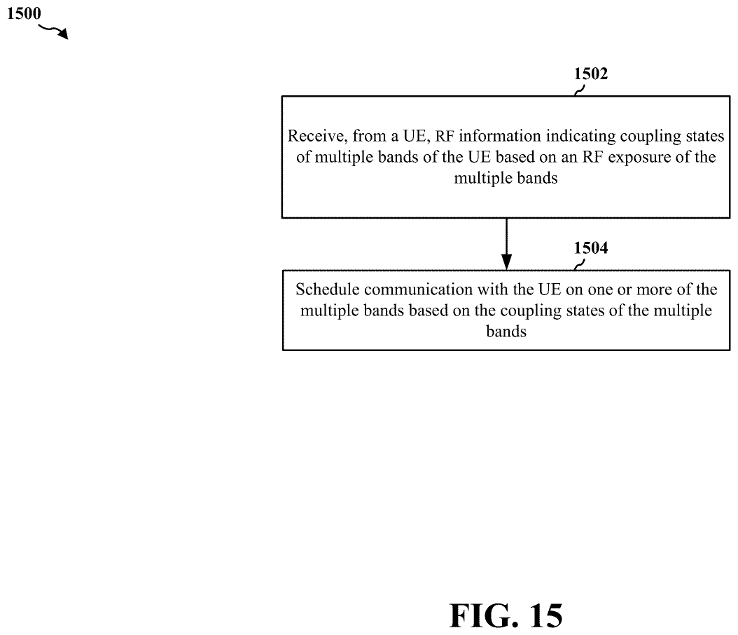

FIG. 15 is a flowchart 1500 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 1104; or the network entity 1802 in the hardware implementation of FIG. 18). The method provides signaling mechanisms to inform the base station of the underlying UE implementation related to the RF exposure associated with the UL transmission. The method allows the base station to better plan future scheduling from the RF exposure standpoint. Hence, it improves the efficiency of wireless communication.

As shown in FIG. 15, at 1502, the network entity may receive, from a UE, RF information indicating coupling states of multiple bands of the UE based on an RF exposure of the multiple bands. The UE may be the UE 104, 350, 1102, or the apparatus 1804 in the hardware implementation of FIG. 18. FIGS. 9, 10, and 11 illustrate various aspects of the steps in connection with flowchart 1500. For example, referring to FIG. 11, the network entity (base station 1104) may receive, at 1106, from a UE 1102, RF information indicating coupling states of multiple bands of the UE based on an RF exposure of the multiple bands. Referring to FIG. 9, the RF information may indicate that band I and band 2 of the UE 1102 are coupled and share an RF exposure budget (e.g., RF exposure budget 1). The RF information may further indicate that band 3 is decoupled to either band 1 or band 2, as band 3 does not share an RF exposure budget with band 1 or band 2. In some aspects, 1502 may be performed by the RF exposure dependency reception component 199.

At 1504, the network entity may schedule communication with the UE on one or more of the multiple bands based on the coupling states of the multiple bands. For example, referring to FIG. 11, the network entity (base station 1104) may, at 1110, schedule communication with the UE 1102 on one or more of the multiple bands based on the coupling states of the multiple bands. In some aspects, 1504 may be performed by the RF exposure dependency reception component 199.

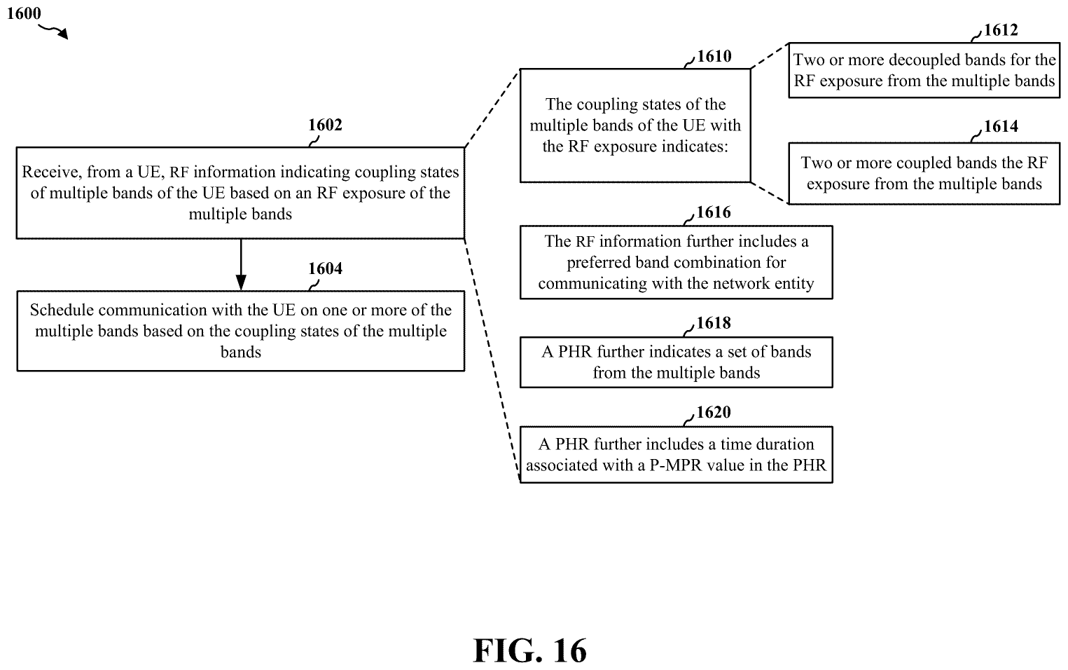

FIG. 16 is a flowchart 1600 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 1104; or the network entity 1802 in the hardware implementation of FIG. 18). The method provides signaling mechanisms to inform the base station of the underlying UE implementation related to the RF exposure associated with the UL transmission. The method allows the base station to better plan future scheduling from the RF exposure standpoint. Hence, it improves the efficiency of wireless communication.

As shown in FIG. 16, at 1602, the network entity may receive, from a UE, RF information indicating coupling states of multiple bands of the UE based on an RF exposure of the multiple bands. The UE may be the UE 104, 350, 1102, or the apparatus 1804 in the hardware implementation of FIG. 18. FIGS. 9, 10, and 11 illustrate various aspects of the steps in connection with flowchart 1600. For example, referring to FIG. 11, the network entity (base station 1104) may receive, at 1106, from a UE 1102, RF information indicating coupling states of multiple bands of the UE based on an RF exposure of the multiple bands. Referring to FIG. 9, the RF information may indicate that band I and band 2 of the UE 1102 are coupled and share an RF exposure budget (e.g., RF exposure budget 1). The RF information may further indicate that band 3 is decoupled to either band 1 or band 2, as band 3 does not share an RF exposure budget with band 1 or band 2. In some aspects, 1602 may be performed by the RF exposure dependency reception component 199.

At 1604, the network entity may schedule communication with the UE on one or more of the multiple bands based on the coupling states of the multiple bands. For example, referring to FIG. 11, the network entity (base station 1104) may, at 1110, schedule communication with the UE 1102 on one or more of the multiple bands based on the coupling states of the multiple bands. In some aspects, 1604 may be performed by the RF exposure dependency reception component 199.

In some aspects, at 1610, the coupling states of the multiple bands of the UE with the RF exposure may indicate one or more of: at 1612, two or more decoupled bands for the RF exposure from the multiple bands; or, at 1614, two or more coupled bands for the RF exposure from the multiple bands. For example, referring to FIG. 9, the coupling states of the multiple bands of the UE may indicate that band 1 and band 2 of the UE are coupled bands and share an RF exposure budget (e.g., RF exposure budget 1), and band 3 is decoupled to either band 1 or band 2, as band 3 does not share an RF exposure budget with band 1 or band 2.

In some aspects, the RF information may further include, at 1616, a preferred band combination for communicating with the network entity. The preferred band combination may include one or more bands of the multiple bands based on an RF exposure metric. For example, referring to FIG. 9, the preferred band combination may include a combination of band 1 and band 3 because band 1 and band 3 are decoupled and do not share an RF exposure budget.

In some aspects, the RF exposure metric may be related to the sharing of an RF exposure budget, and the one or more bands of the multiple bands may not share the RF exposure budget. For example, referring to FIG. 9, the one or more bands of the multiple bands may be band I and band 3, which do not share the RF exposure budget.

In some aspects, the RF information may be included in a PHR. In some aspects, at 1618, the PHR may further indicate a set of bands from the multiple bands, based on a CA configuration associated with an RF exposure metric, for uplink transmission to the network entity. For example, referring to FIG. 11, when the network entity (base station 1104) receives, at 1106, the PHR from the UE 1102, the PHR may indicate a set of bands from the multiple bands, based on a CA configuration associated with an RF exposure metric, for uplink transmission to the network entity.

In some aspects, the PHR may indicate the set of bands through a binary string including multiple bits corresponding to the multiple bands. For example, referring to FIG. 11, when the network entity (base station 1104) receives, at 1106, the PHR from the UE 1102, the PHR may indicate the set of bands through a binary string. For example, the binary string may be a 4-bit binary string [1 0 0 1]. Each bit in the binary string may correspond to one band of the multiple bands, and the string [1 0 0 1] may indicate the first and fourth bands pair well for uplink transmission to the network entity (base station 1104).

In some aspects, at 1620, the PHR may further include a time duration associated with a P-MPR value in the PHR. For example, referring to FIG. 11, when the network entity (base station 1104) receives, at 1106, the PHR from the UE 1102, the PHR may further include a time duration associated with a P-MPR value in the PHR.

In some aspects, the time duration may be indicated as an additional field in the PHR and may correspond to a time period during which the P-MPR value is effective. For example, referring to FIG. 11, when the network entity (base station 1104) receives, at 1106, the PHR may include the time duration, and the time duration in the PHR may be indicated as an additional field in the PHR and may correspond to a time period during which the P-MPR value is effective.

In some aspects, the time duration may be one of a set of predetermined values. For example, the time duration may be one of a set of given values, such as {50, 100, 150, . . . , 500} ms.

In some aspects, the additional field may be a binary field including multiple binary bits. For example, the additional field may be a 3-bit or 4-bit field.

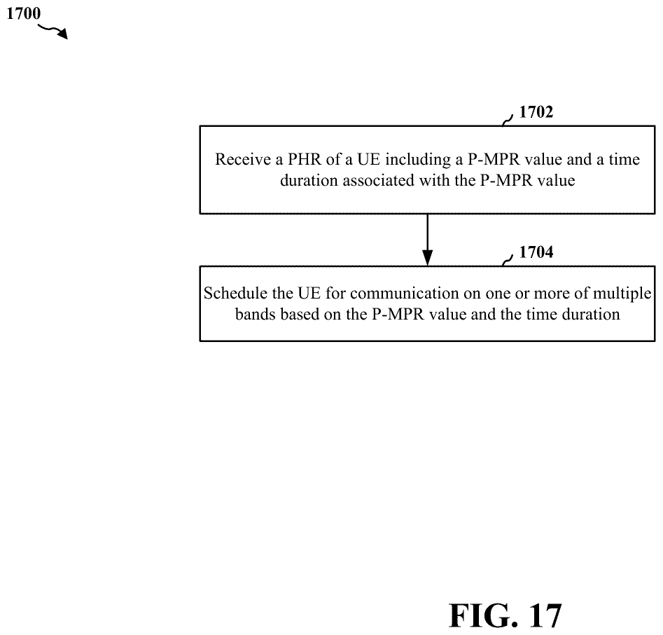

FIG. 17 is a flowchart 1700 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 1104; or the network entity 1802 in the hardware implementation of FIG. 18). The method provides signaling mechanisms to inform the base station of the underlying UE implementation related to the RF exposure associated with the UL transmission. The method allows the base station to better plan future scheduling from the RF exposure standpoint. Hence, it improves the efficiency of wireless communication.

As shown in FIG. 17, at 1702, the network entity may receive a PHR of a UE. The PHR may include a P-MPR value and a time duration associated with the P-MPR value. The UE may be the UE 104, 350, 1102, or the apparatus 1804 in the hardware implementation of FIG. 18. FIGS. 9, 10, and 11 illustrate various aspects of the steps in connection with flowchart 1700. For example, referring to FIG. 11, the network entity (base station 1104) may receive, at 1108, a PHR from a UE 1102. The PHR may include a P-MPR value and a time duration associated with the P-MPR value. In some aspects, 1702 may be performed by the RF exposure dependency reception component 199.

At 1704, the network entity may schedule the UE for communication on one or more of multiple bands based on the P-MPR value and the time duration. For example, referring to FIG. 11, the network entity (base station 1104) may schedule, at 1112, the UE for communication on one or more of multiple bands based on the P-MPR value and the time duration. In some aspects, 1704 may be performed by the RF exposure dependency reception component 199.

In some aspects, the time duration may be indicated as an additional field in the PHR and may correspond to a time period during which the P-MPR value is effective. For example, referring to FIG. 11, when the network entity (base station 1104) receives, at 1108, a PHR from a UE 1102, the PHR may include the time duration, and the time duration in the PHR may be indicated as an additional field in the PHR and may correspond to a time period during which the P-MPR value is effective.

In some aspects, the time duration may be one of a set of predetermined values. For example, the time duration may be one of a set of given values, such as {50, 100, 150, . . . , 500} ms.

In some aspects, the additional field may be a binary field including multiple binary bits. For example, the additional field may be a 3-bit or 4-bit field.

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include at least one cellular baseband processor (or processing circuitry) 1824 (also referred to as a modem) coupled to one or more transceivers 1822 (e.g., cellular RF transceiver). The cellular baseband processor(s) (or processing circuitry) 1824 may include at least one on-chip memory (or memory circuitry) 1824′. In some aspects, the apparatus 1804 may further include one or more subscriber identity modules (SIM) cards 1820 and at least one application processor (or processing circuitry) 1806 coupled to a secure digital (SD) card 1808 and a screen 1810. The application processor(s) (or processing circuitry) 1806 may include on-chip memory (or memory circuitry) 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize the antennas 1880 for communication. The cellular baseband processor(s) (or processing circuitry) 1824 communicates through the transceiver(s) 1822 via one or more antennas 1880 with the UE 104 and/or with an RU associated with a network entity 1802. The cellular baseband processor(s) (or processing circuitry) 1824 and the application processor(s) (or processing circuitry) 1806 may each include a computer-readable medium/memory (or memory circuitry) 1824′, 1806′, respectively. The additional memory modules 1826 may also be considered a computer-readable medium/memory (or memory circuitry). Each computer-readable medium/memory (or memory circuitry) 1824′, 1806′, 1826 may be non-transitory. The cellular baseband processor(s) (or processing circuitry) 1824 and the application processor(s) (or processing circuitry) 1806 are each responsible for general processing, including the execution of software stored on the computer-readable medium/memory (or memory circuitry). The software, when executed by the cellular baseband processor(s) (or processing circuitry) 1824/application processor(s) (or processing circuitry) 1806, causes the cellular baseband processor(s) (or processing circuitry) 1824/application processor(s) (or processing circuitry) 1806 to perform the various functions described supra. The cellular baseband processor(s) (or processing circuitry) 1824 and the application processor(s) (or processing circuitry) 1806 are configured to perform the various functions described supra based at least in part of the information stored in the memory (or memory circuitry). That is, the cellular baseband processor(s) (or processing circuitry) 1824 and the application processor(s) (or processing circuitry) 1806 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1824/application processor(s) (or processing circuitry) 1806 when executing software. The cellular baseband processor(s) (or processing circuitry) 1824/application processor(s) (or processing circuitry) 1806 may be a component of the UE 350 and may include the at least one memory 360 and/or at least one of the TX processor 368, the RX processor 356, and the controller/processor 359. In one configuration, the apparatus 1804 may be at least one processor chip (modem and/or application) and include just the cellular baseband processor(s) (or processing circuitry) 1824 and/or the application processor(s) (or processing circuitry) 1806, and in another configuration, the apparatus 1804 may be the entire UE (e.g., see UE 350 of FIG. 3) and include the additional modules of the apparatus 1804.

As discussed supra, the component 198 may be configured to transmit, to a network entity, RF information indicating coupling states of multiple bands of the UE based on an RF exposure of the multiple bands; and communicate, after providing the RF information indicating the coupling states, with the network entity through one or more of the multiple bands. The component 198 may also be configured to transmit, to a network entity, a PHR including a P-MPR value and a time duration associated with the P-MPR value; and receive scheduling from the network entity after providing the PHR with the P-MPR value and the time duration. The component 198 may be further configured to perform any of the aspects described in connection with the flowcharts in FIG. 12, FIG. 13, and FIG. 14, and/or performed by the UE 1102 in FIG. 11. The component 198 may be within the cellular baseband processor(s) 1824, the application processor(s) 1806, or both the cellular baseband processor(s) 1824 and the application processor(s) 1806. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1804 may include a variety of components configured for various functions. In one configuration, the apparatus 1804, and in particular the cellular baseband processor(s) 1824 and/or the application processor(s) 1806, includes means for transmitting, to a network entity, RF information indicating coupling states of multiple bands of the UE based on an RF exposure of the multiple bands, and means for communicating, after providing the RF information indicating the coupling states, with the network entity through one or more of the multiple bands. The apparatus 1804 may also include means for transmitting, to a network entity, a PHR including a P-MPR value and a time duration associated with the P-MPR value, and means for receiving scheduling from the network entity after providing the PHR with the P-MPR value and the time duration. The apparatus 1804 may further include means for performing any of the aspects described in connection with the flowcharts in FIG. 12, FIG. 13, and FIG. 14, and/or aspects performed by the UE 1102 in FIG. 11. The means may be the component 198 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

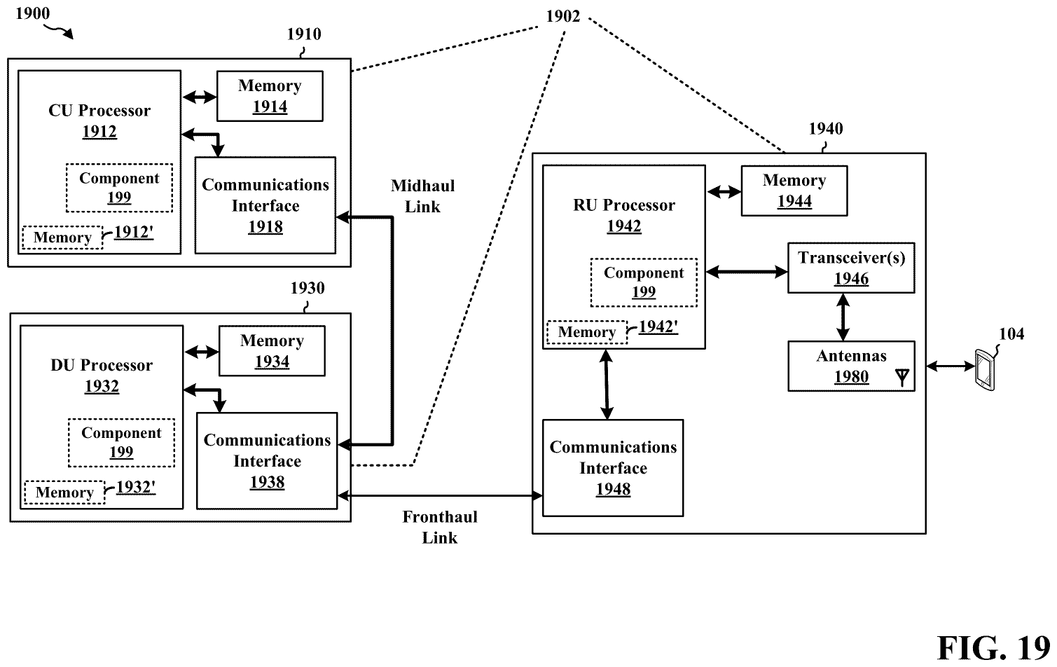

FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, depending on the layer functionality handled by the component 199, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include at least one CU processor (or processing circuitry) 1912. The CU processor(s) (or processing circuitry) 1912 may include on-chip memory (or memory circuitry) 1912′. In some aspects, the CU 1910 may further include additional memory modules 1914 and a communications interface 1918. The CU 1910 communicates with the DU 1930 through a midhaul link, such as an F1 interface. The DU 1930 may include at least one DU processor (or processing circuitry) 1932. The DU processor(s) (or processing circuitry) 1932 may include on-chip memory (or memory circuitry) 1932′. In some aspects, the DU 1930 may further include additional memory modules 1934 and a communications interface 1938. The DU 1930 communicates with the RU 1940 through a fronthaul link. The RU 1940 may include at least one RU processor (or processing circuitry) 1942. The RU processor(s) (or processing circuitry) 1942 may include on-chip memory (or memory circuitry) 1942′. In some aspects, the RU 1940 may further include additional memory modules 1944, one or more transceivers 1946, antennas 1980, and a communications interface 1948. The RU 1940 communicates with the UE 104. The on-chip memory (or memory circuitry) 1912′, 1932′, 1942′ and the additional memory modules 1914, 1934, 1944 may each be considered a computer-readable medium/memory (or memory circuitry). Each computer-readable medium/memory (or memory circuitry) may be non-transitory. Each of the processors (or processing circuitry) 1912, 1932, 1942 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to receive, from a UE, RF information indicating coupling states of multiple bands of the UE based on an RF exposure of the multiple bands; and schedule communication with the UE on one or more of the multiple bands based on the coupling states of the multiple bands. The component 199 may also be configured to receive a PHR of a UE including a P-MPR value and a time duration associated with the P-MPR value; and schedule the UE for communication on one or more of multiple bands based on the P-MPR value and the time duration. The component 199 may be further configured to perform any of the aspects described in connection with the flowcharts in FIG. 15, FIG. 16, and FIG. 17, and/or performed by the base station 1104 in FIG. 11. The component 199 may be within one or more processors of one or more of the CU 1910, DU 1930, and the RU 1940. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1902 may include a variety of components configured for various functions. In one configuration, the network entity 1902 includes means for receiving, from a UE, RF information indicating coupling states of multiple bands of the UE based on an RF exposure of the multiple bands, and means for scheduling communication with the UE on one or more of the multiple bands based on the coupling states of the multiple bands. The network entity 1902 may also include means for receiving a PHR of a UE including a P-MPR value and a time duration associated with the P-MPR value, and means for scheduling the UE for communication on one or more of multiple bands based on the P-MPR value and the time duration. The network entity 1902 may further include means for performing any of the aspects described in connection with the flowcharts in FIG. 15, FIG. 16, and FIG. 17, and/or aspects performed by the base station 1104 in FIG. 11. The means may be the component 199 of the network entity 1902 configured to perform the functions recited by the means. As described supra, the network entity 1902 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. In one aspect, the method may include transmitting, to a network entity, RF information indicating coupling states of multiple bands of the UE based on an RF exposure of the multiple bands; and communicating, after providing the RF information indicating the coupling states, with the network entity through one or more of the multiple bands. In another aspect, the method may include transmitting, to a network entity, a PHR including a P-MPR value and a time duration associated with the P-MPR value; and receiving scheduling from the network entity after providing the PHR with the P-MPR value and the time duration. The method provides signaling mechanisms to inform the base station of the underlying UE implementation related to the RF exposure associated with the UL transmission. The method allows the base station to better plan future scheduling from the RF exposure standpoint. Hence, it improves the efficiency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE including transmitting, to a network entity, RF information indicating coupling states of multiple bands of the UE based on an RF exposure of the multiple bands; and communicating, after providing the RF information indicating the coupling states, with the network entity through one or more of the multiple bands.

Aspect 2 is the method of aspect 1, where the coupling states of the multiple bands of the UE with the RF exposure indicate one or more of: two or more decoupled bands for the RF exposure from the multiple bands; or two or more coupled bands the RF exposure from the multiple bands.

Aspect 3 is the method of any of aspects 1 to 2, where the RF information further includes a preferred band combination for communicating with the network entity. The preferred band combination may include one or more bands of the multiple bands based on an RF exposure metric.

Aspect 4 is the method of aspect 3, where the RF exposure metric is related to the sharing of an RF exposure budget, and the one or more bands of the multiple bands do not share the RF exposure budget.

Aspect 5 is the method of any of aspects 1 to 2, where the RF information is in a PHR that further indicates a set of bands from the multiple bands, based on a CA configuration associated with an RF exposure metric, for uplink transmission to the network entity.

Aspect 6 is the method of aspect 5, where the PHR indicates the set of bands through a binary string. The binary string includes multiple bits corresponding to the multiple bands.

Aspect 7 is the method of any of aspects 2 to 6, where the RF information is in a PHR that further includes a time duration associated with a P-MPR value in the PHR.

Aspect 8 is the method of aspect 7, where the time duration is indicated as an additional field in the PHR and corresponds to a time period during which the P-MPR value is effective.

Aspect 9 is the method of aspect 8, where the time duration is one of a set of predetermined values.

Aspect 10 is the method of aspect 8, where the additional field is a binary field including multiple binary bits.

Aspect 11 is an apparatus for wireless communication at a UE, comprising: a processing system that includes processor circuitry and memory circuitry that stores code and is coupled with the processor circuitry, the processing system configured to cause the UE to perform the method of one or more of aspects 1-10.

Aspect 12 is an apparatus for wireless communication at a UE, comprising: at least one memory; and at least one processor coupled to the at least one memory and, where the at least one processor, individually or in any combination, is configured to perform the method of any of aspects 1-10.

Aspect 13 is the apparatus for wireless communication at a UE, comprising means for performing each step in the method of any of aspects 1-10.

Aspect 14 is an apparatus of any of aspects 11-13, further comprising a transceiver configured to receive or to transmit in association with the method of any of aspects 1-10.

Aspect 15 is a computer-readable medium (e.g., a non-transitory computer-readable medium) storing computer executable code at a UE, the code when executed by at least one processor causes the at least one processor to, individually or in any combination, perform the method of any of aspects 1-10.

Aspect 16 is a method of wireless communication at a UE including transmitting, to a network entity, a PHR including a P-MPR value and a time duration associated with the P-MPR value; and receiving scheduling from the network entity after providing the PHR with the P-MPR value and the time duration.

Aspect 17 is the method of aspect 16, wherein the time duration is indicated as an additional field in the PHR and corresponds to a time period during which the P-MPR value is effective.

Aspect 18 is the method of aspect 17, where the time duration is one of a set of predetermined values.

Aspect 19 is the method of aspect 17, where the additional field is a binary field including multiple binary bits.

Aspect 20 is an apparatus for wireless communication at a UE, comprising: a processing system that includes processor circuitry and memory circuitry that stores code and is coupled with the processor circuitry, the processing system configured to cause the UE to perform the method of one or more of aspects 16-19.

Aspect 21 is an apparatus for wireless communication at a UE, comprising: at least one memory; and at least one processor coupled to the at least one memory and, where the at least one processor, individually or in any combination, is configured to perform the method of any of aspects 16-19.

Aspect 22 is the apparatus for wireless communication at a UE, comprising means for performing each step in the method of any of aspects 16-19.

Aspect 23 is an apparatus of any of aspects 20-22, further comprising a transceiver configured to receive or to transmit in association with the method of any of aspects 16-19.

Aspect 24 is a computer-readable medium (e.g., a non-transitory computer-readable medium) storing computer executable code at a UE, the code when executed by at least one processor causes the at least one processor to, individually or in any combination, perform the method of any of aspects 16-19.

Aspect 25 is a method of wireless communication at a network entity. The method includes receiving, from a UE, RF information indicating coupling states of multiple bands of the UE based on an RF exposure of the multiple bands; and scheduling communication with the UE on one or more of the multiple bands based on the coupling states of the multiple bands.

Aspect 26 is the method of aspect 25, where the coupling states of the multiple bands of the UE with the RF exposure may indicate one or more of: two or more decoupled bands for the RF exposure from the multiple bands; or two or more coupled bands for the RF exposure from the multiple bands.

Aspect 27 is the method of any of aspects 25 to 26, where the RF information further includes a preferred band combination for communicating with the network entity. The preferred band combination includes one or more bands of the multiple bands based on an RF exposure metric.

Aspect 28 is the method of aspect 27, where the RF exposure metric is related to the sharing of an RF exposure budget, and the one or more bands of the multiple bands may not share the RF exposure budget.

Aspect 29 is the method of any of aspects 25 to 28, where the RF information is in a PHR that further indicates a set of bands from the multiple bands, based on a CA configuration associated with an RF exposure metric, for uplink transmission to the network entity.

Aspect 30 is the method of aspect 29, where the PHR indicates the set of bands through a binary string including multiple bits corresponding to the multiple bands.

Aspect 31 is the method of any of aspects 26 to 30, where the PHR further includes a time duration associated with a P-MPR value in the PHR.

Aspect 32 is the method of aspect 31, where the time duration is indicated as an additional field in the PHR and corresponds to a time period during which the P-MPR value is effective.

Aspect 33 is the method of aspect 32, where the time duration is one of a set of predetermined values.

Aspect 34 is the method of aspect 32, where the additional field is a binary field including multiple binary bits.

Aspect 35 is an apparatus for wireless communication at a network entity, comprising: a processing system that includes processor circuitry and memory circuitry that stores code and is coupled with the processor circuitry, the processing system configured to cause the network entity to perform the method of one or more of aspects 25-34.

Aspect 36 is an apparatus for wireless communication at a network entity, comprising: at least one memory; and at least one processor coupled to the at least one memory and, where the at least one processor, individually or in any combination, is configured to perform the method of any of aspects 25-34.

Aspect 37 is the apparatus for wireless communication at a network entity, comprising means for performing each step in the method of any of aspects 25-34.

Aspect 38 is an apparatus of any of aspects 35-37, further comprising a transceiver configured to receive or to transmit in association with the method of any of aspects 25-34.

Aspect 39 is a computer-readable medium (e.g., a non-transitory computer-readable medium) storing computer executable code at a network entity, the code when executed by at least one processor causes the at least one processor to, individually or in any combination, perform the method of any of aspects 25-34.

Aspect 40 is a method of wireless communication at a network entity. The method includes receiving a PHR of a UE including a P-MPR value and a time duration associated with the P-MPR value; and scheduling the UE for communication on one or more of multiple bands based on the P-MPR value and the time duration.

Aspect 41 is the method of aspect 40, where the time duration is indicated as an additional field in the PHR and corresponds to a time period during which the P-MPR value is effective.

Aspect 42 is the method of aspect 41, where the time duration is one of a set of predetermined values.

Aspect 43 is the method of aspect 41, where the additional field is a binary field including multiple binary bits.

Aspect 44 is an apparatus for wireless communication at a network entity, comprising: a processing system that includes processor circuitry and memory circuitry that stores code and is coupled with the processor circuitry, the processing system configured to cause the network entity to perform the method of one or more of aspects 40-43.

Aspect 45 is an apparatus for wireless communication at a network entity, comprising: at least one memory; and at least one processor coupled to the at least one memory and, where the at least one processor, individually or in any combination, is configured to perform the method of any of aspects 40-43.

Aspect 46 is the apparatus for wireless communication at a network entity, comprising means for performing each step in the method of any of aspects 40-43.

Aspect 47 is an apparatus of any of aspects 44-46, further comprising a transceiver configured to receive or to transmit in association with the method of any of aspects 40-43.

Aspect 48 is a computer-readable medium (e.g., a non-transitory computer-readable medium) storing computer executable code at a network entity, the code when executed by at least one processor causes the at least one processor to, individually or in any combination, perform the method of any of aspects 40-43.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the UE to:
transmit, to a network entity, radio frequency (RF) information indicating coupling states of multiple bands of the UE based on an RF exposure of the multiple bands; and
communicate, after providing the RF information indicating the coupling states, with the network entity through one or more of the multiple bands.

2. The apparatus of claim 1, further comprising a transceiver coupled to the at least one processor, wherein to transmit the RF information, the at least one processor, individually or in any combination, is configured to cause the UE to transmit the RF information via the transceiver, and wherein the coupling states of the multiple bands of the UE with the RF exposure indicates one or more of:
two or more decoupled bands for the RF exposure from the multiple bands; or
two or more coupled bands the RF exposure from the multiple bands.

3. The apparatus of claim 2, wherein the RF information further comprises:
a preferred band combination for communicating with the network entity, wherein the preferred band combination comprises one or more bands of the multiple bands based on an RF exposure metric.

4. The apparatus of claim 3, wherein the RF exposure metric is related to a sharing of an RF exposure budget, and the one or more bands of the multiple bands do not share the RF exposure budget.

5. The apparatus of claim 2, wherein the RF information is indicated in a power headroom report (PHR) that further indicates:
a set of bands from the multiple bands, based on a carrier aggregation (CA) configuration associated with an RF exposure metric, for uplink transmission to the network entity.

6. The apparatus of claim 5, wherein the PHR indicates the set of bands through a binary string comprising multiple bits corresponding to the multiple bands.

7. The apparatus of claim 2, wherein the RF information is indicated in a power headroom report (PHR) that further includes:
a time duration associated with a power management maximum power reduction (P-MPR) value in the PHR.

8. The apparatus of claim 7, wherein the time duration is indicated as an additional field in the PHR and corresponds to a time period during which the P-MPR value is effective.

9. The apparatus of claim 8, wherein the time duration is one of a set of predetermined values.

10. The apparatus of claim 8, wherein the additional field is a binary field comprising multiple binary bits.

11. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the UE to:
transmit, to a network entity, a power headroom report (PHR) including a power management maximum power reduction (P-MPR) value and a time duration associated with the P-MPR value; and
receive scheduling from the network entity after providing the PHR with the P-MPR value and the time duration.

12. The apparatus of claim 11, further comprising a transceiver coupled to the at least one processor, wherein to transmit the PHR, the at least one processor, individually or in any combination, is configured to cause the UE to transmit the PHR via the transceiver, and wherein the time duration is indicated as an additional field in the PHR and corresponds to a time period during which the P-MPR value is effective.

13. The apparatus of claim 12, wherein the time duration is one of a set of predetermined values.

14. The apparatus of claim 12, wherein the additional field is a binary field comprising multiple binary bits.

15. An apparatus for wireless communication at a network entity, comprising:
at least one memory; and
at least one processor coupled to the at least one memory and, based at least in part on information stored in the at least one memory, the at least one processor, individually or in any combination, is configured to cause the network entity to:
receive, from a user equipment (UE), radio frequency (RF) information indicating coupling states of multiple bands of the UE based on an RF exposure of the multiple bands; and
schedule communication with the UE on one or more of the multiple bands based on the coupling states of the multiple bands.

16. The apparatus of claim 15, further comprising a transceiver coupled to the at least one processor, wherein to receive the RF information, the at least one processor, individually or in any combination, is configured to cause the network entity to receive the RF information via the transceiver, and wherein the coupling states of the multiple bands of the UE with the RF exposure indicates one or more of:
two or more decoupled bands for the RF exposure from the multiple bands; or
two or more coupled bands for the RF exposure from the multiple bands.

17. The apparatus of claim 16, wherein the RF information further comprises:
a preferred band combination for communicating with the network entity, wherein the preferred band combination comprises one or more bands of the multiple bands based on an RF exposure metric.

18. The apparatus of claim 17, wherein the RF exposure metric is related to a sharing of an RF exposure budget, and the one or more bands of the multiple bands do not share the RF exposure budget.

19. The apparatus of claim 16, wherein the RF information is indicated in a power headroom report (PHR) that further indicates:
a set of bands from the multiple bands, based on a carrier aggregation (CA) configuration associated with an RF exposure metric, for uplink transmission to the network entity.

20. The apparatus of claim 19, wherein the PHR indicates the set of bands through a binary string comprising multiple bits corresponding to the multiple bands.

21. The apparatus of claim 16, wherein the RF information is indicated in a power headroom report (PHR) that further includes:
a time duration associated with a power management maximum power reduction (P-MPR) value in the PHR.

22. The apparatus of claim 21, wherein the time duration is indicated as an additional field in the PHR and corresponds to a time period during which the P-MPR value is effective.

23. The apparatus of claim 22, wherein the time duration is one of a set of predetermined values.

24. The apparatus of claim 22, wherein the additional field is a binary field comprising multiple binary bits.

25. An apparatus for wireless communication at a network entity, comprising:
at least one memory; and
at least one processor coupled to the at least one memory and, based at least in part on information stored in the at least one memory, the at least one processor, individually or in any combination, is configured to:
receive a power headroom report (PHR) of a user equipment (UE) including a power management maximum power reduction (P-MPR) value and a time duration associated with the P-MPR value; and
schedule the UE for communication on one or more of multiple bands based on the P-MPR value and the time duration.

26. The apparatus of claim 25, further comprising a transceiver coupled to the at least one processor, wherein to receive the PHR, the at least one processor, individually or in any combination, is configured to cause the network entity to receive the PHR via the transceiver, and wherein the time duration is indicated as an additional field in the PHR and corresponds to a time period during which the P-MPR value is effective.

27. The apparatus of claim 26, wherein the time duration is one of a set of predetermined values.

28. The apparatus of claim 26, wherein the additional field is a binary field comprising multiple binary bits.
